(19) United States
(12) Patent Application Publication
(10) Pub. No.: US 2010/0084069 A1
(43) Pub. Date: Apr. 8, 2010

(54) HEAVY DUTY TIRE

(76) Inventor: Kiyoto MARUOKA, Kobe-shi (JP)

Correspondence Address: BIRCH STEWART KOLASCH & BIRCH, PO BOX 747, FALLS CHURCH, VA, 22040-0747, US

(21) Appl. No.: 12/510,483

(22) Filed: Jul. 28, 2009

(30) Foreign Application Priority Data
Oct. 3, 2008 (JP) 2008-258801

(51) Int. Cl. B60C 9/00

(52) U.S. Cl. 152/527

(57) ABSTRACT

A heavy duty tire comprises a belt disposed radially outside a carcass in the tread portion, and a belt cushion rubber layer inserted between the carcass and each axial edge portion of the belt. The complex elastic modulus of the belt cushion rubber layer is in a range of from 3.5 to 4.5 MPa. The belt is made up of three plies each made of parallel steel cords inclined at an angle of from 15 to 23 degrees with respect to the tire equator. With respect to the tire equator, the inclination of the belt cords of the radially innermost first ply is opposite to that of the middle second belt ply. The second belt ply is narrower than the first belt ply and wider than the radially outermost third belt ply. The ply strengths S1, S2 and S3 of the first, second and third belt plies, respectively, satisfy: (1) S1>S2, (2) S1>S3, (3) 55≦S1≦75, and (4) 1.25≦S1/S2≦1.65.

### BACKGROUND OF THE INVENTION

The present invention relates to a pneumatic tire, more particularly to a heavy duty tire provided with a tread reinforcing belt having a three-ply structure capable of reducing the tire weight while increasing the tire strength.

In recent years, as well as passenger car tires, pneumatic tires for heavy vehicles, e.g. trucks, buses and the like are strongly required to reduce the mass of tire from the viewpoint of fuel saving and resource saving.

Such heavy duty tires are often used under very severe service conditions, therefore, as the tread reinforcing belt (breaker) therefor, four-ply structures of steel cords have been widely used for truck/bus tire sizes.

FIG. 4 shows a typical four-ply structure, wherein, with respect to the tire equator,

the steel cords of the radially innermost first ply A1 are laid at an angle θ1 in a range of from 40 to 80 degrees,
the steel cords of the second ply A2 thereon are laid at an angle θ2 in a range of from 15 to 30 degrees,
the steel cords of the third ply A3 thereon are laid at an angle θ3 in the range of from 15 to 30 degrees,
the absolute value of the angle θ2 is same as that of the angle θ3, but the inclining direction of the cords of the second ply A2 is opposite to that of the third ply A3, and
the inclining direction of the cords of the second ply A2 is same as that of the first ply A1, but the absolute value of the angle θ2 is different from that of the angle θ1, thereby the cords of the first, second and third plies form a stiff truss structure.

In the Japanese Patent Application Publication No. JP-2005-212742, the inventor of the present invention has proposed a heavy duty tire in which a three-ply structure as shown in FIG. 5 is adopted for the tread reinforcing belt, wherein

the first, second and third belt plies A1, A2 and A3 are made of steel cords laid at angles θ1, θ2 and θ3 in a range of from 16 to 22 degrees,
the inclining direction of the cords of the second ply A2 is same as that of the third ply A3, but opposite to that of the first ply A1,
the first belt ply A1 is wider than the second belt ply A2 which is wider than the third belt ply A3,
the ply strength S1 of the first belt ply A1, the ply strength S2 of the second belt ply A2 and the ply strength S3 of the third belt ply A3 satisfy the following conditions:

### (1) 48≦S1≦63, (2) 0.50≦S1/(S2+S3)≦0.65, and

(3) S1≧S2>S3, wherein the ply strength S1, S2, S3 (kN/5 cm) is defined by the product of the break strength (kN) of one steel cord and the cord count/5 cm,
a shock absorbing rubber layer which has a complex elastic modulus of from 7.0 to 11.0 Mpa, a loss tangent of 0.10 to 0.20, a thickness of from 1.0 to 2.0 mm, and a width of 50% or more of the first belt ply width is disposed between the first belt ply and carcass, and
a cushion rubber which has a complex elastic modulus of from 3.0 to 6.5 Mpa, a loss tangent of 0.03 to 0.07 and a triangular cross-sectional shape, is disposed on each side of the shock absorbing rubber layer and between the first belt ply and carcass.

In order to fulfill requirements for further improvements in the tire strength and tire life rooted in resource saving, the inventor studied the above-mentioned three-ply belt structure and found that it had a room for further improvements and accomplished the present invention. Therefore, according to its major aspects and briefly recited, the present invention is an improvement to the three-ply belt structure proposed in the Japanese Patent Application Publication No. JP-2005-212742.

### SUMMARY OF THE INVENTION

An object of the present invention is therefore, to provide a heavy duty tire with a tread reinforcing belt of a three-ply structure, in which the tire strength can be increased, while maintaining or further reducing the mass of the tire.

According to the present invention, a heavy duty tire comprises

a tread portion,

a pair of sidewall portions,

a pair of bead portions each with a bead core therein,

a carcass extending between the bead portions through the tread portion and sidewall portions,

a belt disposed radially outside the carcass in the tread portion, and

a belt cushion rubber layer having a wedge-shaped cross sectional shape and inserted between the carcass and each axial edge portion of the belt, wherein

the belt is made up of three plies: a radially innermost first ply, a middle second belt ply thereon and a radially outermost third belt ply thereon, each made of parallel steel cords inclined at an angle in a range of from 15 to 23 degrees with respect to the tire equator,

with respect to the tire equator, the inclination of the belt cords of the first belt ply is opposite to the inclination of the belt cords of the second belt ply,

the axial width W2 of the second belt ply is less than the axial width W1 of the first belt ply and more than the axial width W3 of the third belt ply,

the ply strength S1 of the first belt ply, the ply strength S2 of the second belt ply, and the ply strength S3 of the third belt ply satisfy the following conditions (1)-(4):

(1) S1>S2

(2) S1>S3

(3) 55≦S1≦75 and

(4) 1.25≦S1/S2≦1.65, and

the complex elastic modulus of the belt cushion rubber layer is in a range of from 3.5 to 4.5 Mpa.

In the present invention, the ply strength S1, S2, S3 (generically S) is defined as the total of break strengths (or total of loads at break) in kN of the belt cords embedded in the belt ply 7A, 7B, 7C per 5 cm width perpendicularly to the longitudinal direction of the embedded belt cords.

In the case of a belt ply in which belt cords having identical break strength (or load at break) E kN are embedded at a cord count N/5 cm width, the ply strength S (kN/5 cm) can be obtained by multiplying E by N.

The complex elastic modulus is measured under the following conditions according to Japanese Industrial Standard JIS-K6394 “Testing methods of dynamic properties for rubber, vulcanized of thermoplastic” for example by the use of a viscoelastic spectrometer manufactured by Iwamoto Seisakusyo:

| Temperature: | 70 deg. C. |
|---|---|
| Frequency: | 10 Hz |
| Strain: | tension |
| Initial strain: | 10% |
| Amplitude: | +/−1% |

The break strength of a belt cord is measured under the following condition according to Japanese Industrial Standard JIS-G3510 “Testing methods for steel tire cords”, section 6.4 “Load at break and Elongation at break”:

Tension rate: 50 mm/minute

In this application, various dimensions, positions and the like refer to those under a normally inflated unloaded condition of the tire unless otherwise noted.

The normally inflated unloaded condition is such that the tire is mounted on a standard wheel rim and inflate to a standard pressure but loaded with no tire load.

The standard wheel rim is a wheel rim officially approved for the tire by standard organization, i.e. JATMA (Japan and Asia), T&RA (North America), ETRTO (Europe), STRO (Scandinavia) and the like. The standard pressure and the standard tire load are the maximum air pressure and the maximum tire load for the tire specified by the same organization in the Air-pressure/Maximum-load Table or similar list. For example, the standard wheel rim is the “standard rim” specified in JATMA, the “Measuring Rim” in ETRTO, the “Design Rim” in TRA or the like. The standard pressure is the “maximum air pressure” in JATMA, the “Inflation Pressure” in ETRTO, the maximum pressure given in the “Tire Load Limits at Various Cold Inflation Pressures” table in TRA or the like. The standard load is the “maximum load capacity” in JATMA, the “Load Capacity” in ETRTO, the maximum value given in the above-mentioned table in TRA or the like.

The undermentioned tread width TW is the axial distance between the tread edges E measured in the normally inflated unloaded condition. The tread edges E are the axial outermost edges of the ground contacting patch (camber angle=0) in a normally inflated loaded condition.

The normally inflated loaded condition is such that the tire is mounted on the standard wheel rim and inflate to the standard pressure and loaded with the standard tire load.

### BRIEF DESCRIPTION OF THE DRAWINGS

FIG. 1 is a cross sectional view of a heavy duty tire according to the present invention under the normally-inflated unloaded condition.

FIG. 2 is an enlarged cross sectional view of the shoulder portion of the tire.

FIG. 3 is a schematic plan view showing an example of the belt cord arrangement of the three-ply belt structure according to the present invention.

FIG. 4 is a schematic plan views showing a belt cord arrangement of a conventional four-ply belt structure.

FIG. 5 is a schematic plan views showing the belt cord arrangement of the prior art three-ply belt structure.

### DESCRIPTION OF THE PREFERRED EMBODIMENT

An embodiment of the present invention will now be described in detail in conjunction with accompanying drawings.

In the drawings, heavy duty tire 1 according to the present invention comprises: a tread portion 2, a pair of sidewall portions 3, a pair of bead portions 4 each with a bead core 5 therein, a carcass 6 extending between the bead portions 4 through the tread portion 2 and sidewall portions 3, a belt 7 disposed radially outside the carcass 6 in the tread portion 2, and a belt cushion rubber layer 9 having a wedge-shaped cross sectional shape and inserted between the carcass 6 and each axial edge portion of the belt 7.

The carcass 6 is composed of at least one carcass ply 6A (in this embodiment only one carcass ply 6A) of carcass cords arranged radially at an angle of from 80 to 90 degrees with respect to the tire equator C. The carcass ply 6A extends between the bead portions 4 through the tread portion 2 and sidewall portions 3 and is turned up around the bead core 5 in each of the bead portions 4 from the inside to the outside of the tire so as to form a pair of turned up portions 6b and a main portion 6a therebetween.

In this embodiment, the carcass cords are steel cords. The carcass 6 however may be composed of a plurality of plies of organic fiber cords, e.g. aromatic polyamide, rayon and the like.

The bead portions 4 are each provided between the main portion 6a and turned up portion 6b of the carcass ply 6A with a rubber bead apex 8. The rubber bead apex 8 is made of a hard rubber having a hardness of from 70 to 98 degrees when measured at a temperature of 23 degrees C. according to JIS-K6253 with a type-A durometer (namely, durometer A hardness), and extended radially outwardly from the bead core 5 in a tapered manner.

Further, the bead portions 4 are each provided with a bead reinforcing layer 12. The bead reinforcing layer 12 is composed of a single ply of steel cords laid at an angle of in a range of from 10 to 60 degrees with respect to the tire circumferential direction. In this embodiment, the bead reinforcing layer 12 comprises:

a base part 12b disposed along the radially inside of the base part of the carcass beneath bead core;
an axially outer part 12o extending radially outwardly from the base part 12b along the turned up portion 6b; and
an axially inner part 12i extending radially outwardly from the base part 12b along the main portion 6a, whereby the bead reinforcing layer 12 has a U-shaped cross sectional shape. In order to prevent damage starting from the radially outer ends of the axially inner part 12i and axially outer part 12o, these ends are positioned radially inside the radially outer end of the turned up portion 6b.

As a modification of the bead reinforcing layer 12, the axially outer part 12o or axially inner part 12i may be omitted or more specifically, the radially outer end of one of them may be positioned as low as the radially outer end of the bead core.

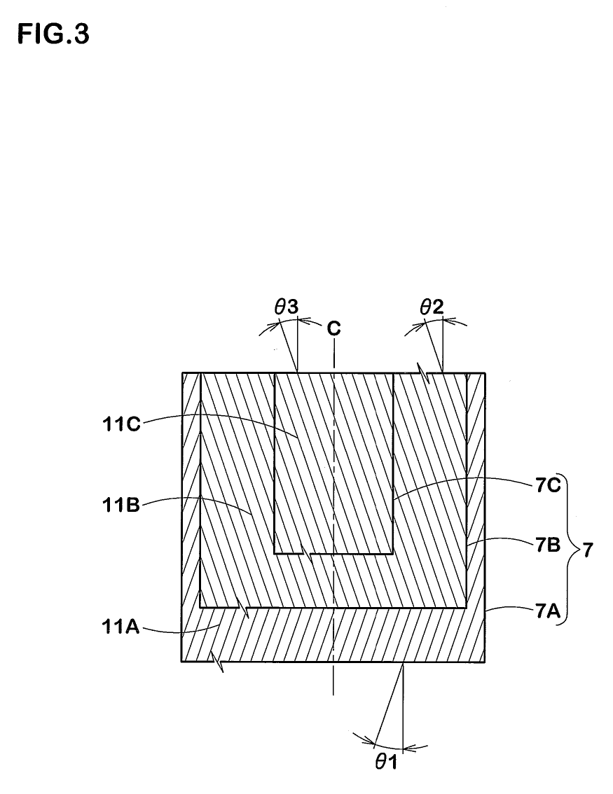

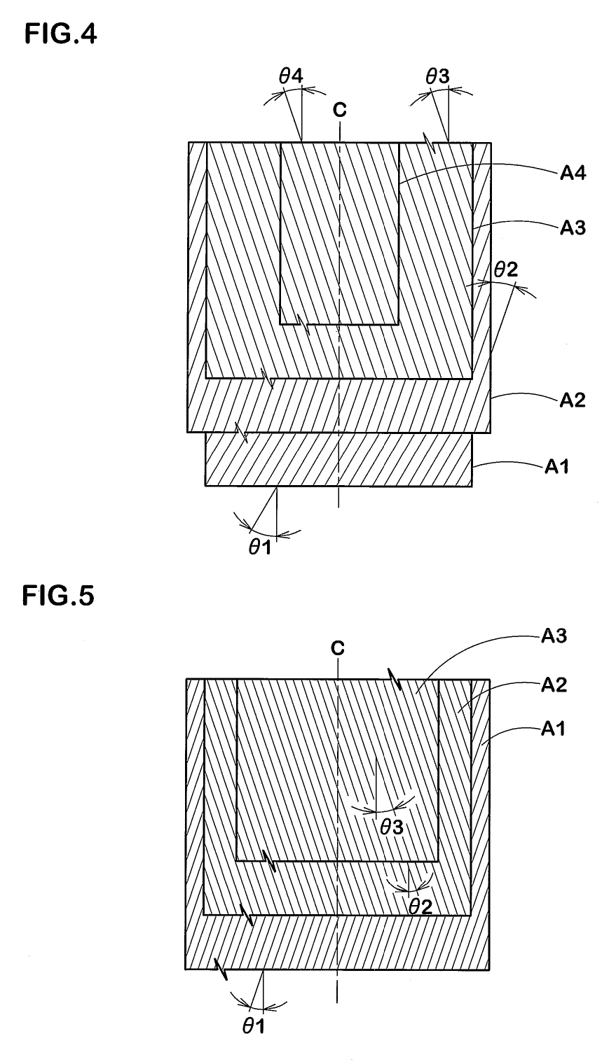

The belt 7 is made up of three plies: a radially innermost first ply 7A, a middle second belt ply 7B thereon, and a radially outermost third belt ply 7C thereon, wherein as shown in FIG. 3, each ply (7A, 7B, 7C) is made of parallel steel cords inclined at an angle (θ1, θ2, θ3) in a range of from 15 to 23 degrees with respect to the tire equator.

The absolute values of the three angles θ1, θ2 and θ3 are substantially same as each other.
With respect to the tire equator c, the belt cords 11A of the first belt ply 7A are inclined to one direction (in FIG. 3, right side upward inclination), whereas the belt cords 11B of the second belt ply 7B and the belt cords 11C of the third belt ply 7C are inclined to the opposite direction (in FIG. 3, left side upward inclination) to that of the first belt ply 7A.

As explained above, the cord angles θ1, θ2 and θ3 of all the belt plies are set at relatively small values, and the belt cords 11A are arranged crosswise to the belt cords 11B to form a stiff truss structure in cooperation with the carcass cords, therefore, the belt 7 is improved in the hoop effect and rigidity at the same time. Consequently, the steering stability can be maintained although the number of the belt plies is decreased down to three to achieve a weight reduction.

If the angles θ1, θ2 and θ3 are less than 15 degrees, the lateral stiffness of the ply and the rigidity of the tread portion become insufficient. If more than 23 degrees, the circumferential rigidity of the tread portion decreases. Therefore, in either case, it becomes difficult to provide necessary steering stability.

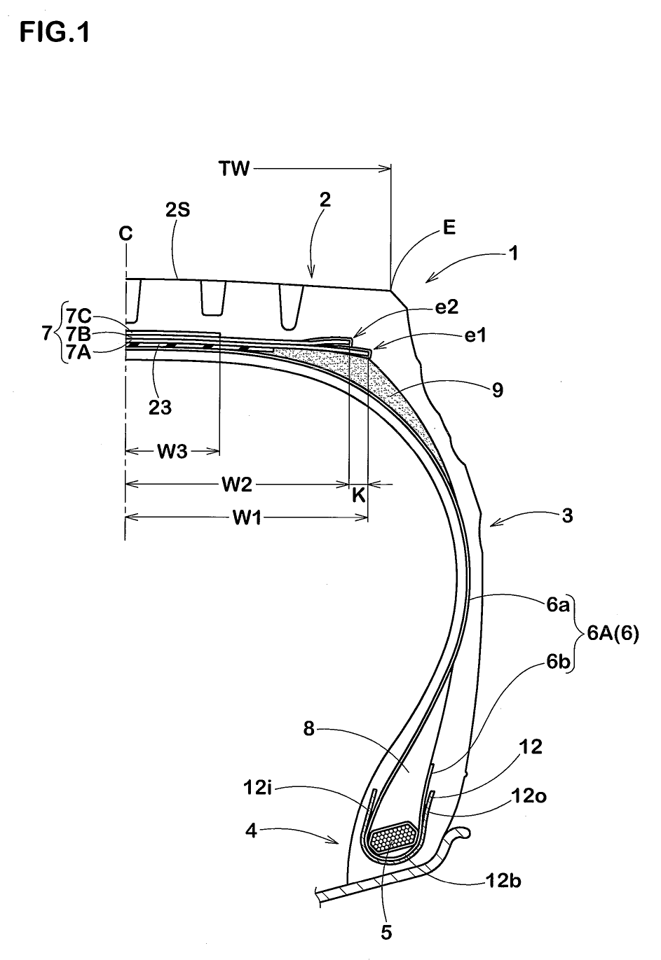

As shown in FIG. 1, the axial widths W1, W2 and W3 of the first, second and third belt plies 7A, 7B and 7C, respectively, satisfy the following condition: W1>W2>W3.

The axial width W1 of the first belt ply 7A is set to be not less than 0.7 times, preferably not less than 0.8 times, but not more than 0.97 times, preferably not more than 0.95 times the tread width TW so as to enable the belt to reinforce the tread portion 2 across the entire tread width.
If the width W1 is less than 0.7 times the tread width TW, the constricting force becomes insufficient in the tread shoulder portion, and the steering stability and uneven wear resistance are liable to deteriorate. If the width W1 is more than 0.97 times the tread width TW, it becomes difficult to reuse the tire by retreading.

The axial width W2 of the second belt ply 7B is set to be not less than 0.8 times, preferably not less than 0.9 times the axial width W1 of the first belt ply 7A.

If the width W2 is less than 0.8 times the axial width W1, the steering stability and uneven wear resistance are deteriorated.
If the width W2 is too large, since the edges approximate those of the first belt ply 7A, stress tends to concentrate on the vicinity of the edges, decreasing the durability.
In this light, it is preferable that the axial distance K between the axially outer end e1 of the first belt ply 7A and the axially outer end e2 of the second belt ply 7B is at least 5 mm.

Further, from the point of view of the tire strength, the axial width W3 of the third belt ply 7C is set to be not less than 0.4 times, preferably not less than 0.5 times the axial width W2 of the second belt ply 7B.

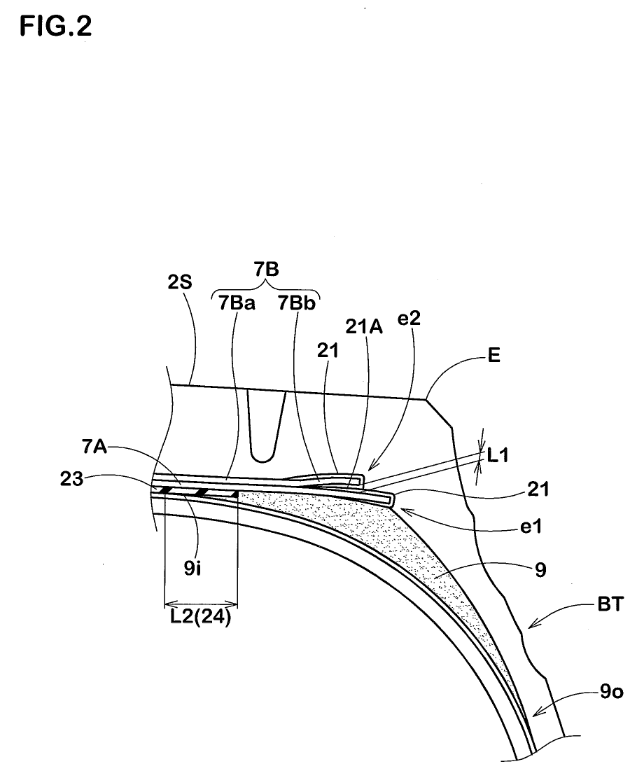

As shown in FIG. 2, in the cross section of the tire, the first belt ply 7A extends substantially parallel with the tread face 2S. In other words, the profile of the first belt ply 7A is substantially parallel with the tread profile.

The second belt ply 7B comprises: a central main part 7Ba abutting on the radially outer surface of the first belt ply 7A; and a pair of axial edge portions 7Bb each extending axially outwardly from one of the axial edges of the central main part 7Ba, while separating from the first belt ply 7A and gradually increasing the distance therefrom towards the extreme end e2 of the edge portion 7Bb.

The third belt ply 7C abuts on the radially outer surface of the central main part 7Ba of the second belt ply 7B. The axial edges of third belt ply 7C are positioned on the central main part 7Ba far from the edge portions 7Bb.

In the wedge-shaped space 20 formed between the edge portion 7Bb and the first belt ply 7A, there is inserted a ply cushion rubber layer 21A. The ply cushion rubber layer 21A can mitigate the stress concentration on the extreme end e2 to prevent a separation failure between the belt plies 7A and 7B spreading from the extreme end e2.

For that purpose, the distance L1 of the extreme end e2 from the first belt ply 7A, namely, the thickness of the ply cushion rubber layer 21A at the extreme end e2 is preferably set in a range of not less than 2.0 mm, more preferably not less than 2.5 mm.

In this embodiment, the ply cushion rubber layer 21A is formed by a part of an edge covering rubber 21 of a U-shaped cross section wrapping the axial edge e1 of the first belt ply 7A and an edge covering rubber 21 of a U-shaped cross section wrapping the axial edge e2 of the second belt ply 7B.

Due to the difference in the profile between the first belt ply 7A and the carcass 6, the distance between the first belt ply 7A and the carcass 6 gradually continuously increases towards the axial edge e1 from the axially inside.

In the wedge-shaped space 22 formed between the axial edge portion of the first belt ply 7A and the carcass 6, there is inserted a belt cushion rubber layer 9. The belt cushion rubber layer 9 has its maximum thickness at the axial edge e1, and the thickness thereof gradually decreases towards its axially inner edge 9i and axially outer edge 9o. Thus, the belt cushion rubber layer 9 has substantially a triangular cross section. The axially outer edge 9o of the belt cushion rubber layer 9 reaches to the upper sidewall portion so called buttress portion BT beyond the tread edge Te. But, the axially outer edge 9o does not reach to the position in which the maximum section width of the carcass lies.

The belt cushion rubber layer 9 can mitigate the stress concentration on the axial edge e1 of the first belt ply 7A to prevent a separation failure between the belt ply 7A and carcass 6 spreading from the axial edge e1.

According to the present invention, ply strengths S1, S2 and S3 (kN/5 cm) of the first, second and third belt plies 7A, 7B and 7C, respectively, are set to satisfy the following conditions (1)-(4):

(1) S1>S2

(2) S1>S3

(3) 55≦S1≦75 and

(4) 1.25≦S1/S2≦1.65.

In this embodiment, in each belt ply 7A, 7B or 7C, the belt ply is made up of the identical belt cords having a break strength E kN, therefore, the ply strength S is equal to E multiplied by the cord count N/5 cm width.

When the tire rolls over objects on the road surface, the tread portion and the belt 7 therein are deflected concavely towards the inside of the tire. Therefore, the radially innermost first belt ply 7A is subjected to largest tension stress, and the belt cords therein have a highest probability of breaking. Thus, the contribution to the tire strength is most in the case of the first belt ply 7A. The next is the second belt ply 7B. The third belt ply 7C is least.

The way to most effectively increase the tire strength is therefore, to increase the ply strength S1 of the first belt ply 7A more than the second ply 7B and third ply 7C.

The present inventor discovered through experiments that it is very important for increasing the tire strength to decrease the ply strength S2 of the second belt ply 7B, contrary to common knowledge, down to at most 0.8 times the ply strength S1 of the first belt ply 7A, namely, the ratio S1/S2 is at least 1.25. The second belt ply 7B has a function to restrict the movement of the belt cords 11A of the first belt ply 7A. Therefore, if the ply strength S2 of the second belt ply 7B is high, as the movement of the belt cords 11A of the first belt ply 7A is restricted, the belt cords 11A can not change their cord angles locally according to the deflection of the tread portion. As a result, the tension and stress are partially increased, and in the worst case, a cord breaking failure occurs in the first belt ply 7A.

By decreasing the ply strength S2 so as to satisfy a ratio S1/S2 of not less than 1.25, the restricting effect on the movement and angle change of the belt cords 11A of the first belt ply 7A is decreased, and the local increase of the tension and stress is reduced to improve the tire strength. Therefore, the ratio S1/S2 is limited to not less than 1.25, preferably not less than 1.35.

However, if the ratio S1/S2 is excessively increased, the hoop effect of the belt 7 becomes insufficient and the cornering force decreases and the steering stability tends to deteriorate, therefore, the ratio S1/S2 is limited to not more than 1.65, preferably not more than 1.55.

If the ply strength S1 is less than 55 kN/5 cm, it is difficult to provide a sufficient tire strength. Therefore, the ply strength S1 is limited to not more than 55 kN/5 cm, preferably not less than 60 kN/5 cm.

If the ply strength S1 is more than 75 kN/5 cm, it results in an excessive quality, and it is disadvantageous for the reduction in the tire weight due to the increased steel amount. Therefore, the ply strength si is limited to not more than 75 kN/5 cm, preferably not more than 70 kN/5 cm.

The ply strength S3 of the third belt ply 7C is preferably set to be not more than the ply strength S2 of the second belt ply 7B from a point of view of the weight reduction and the contribution to the tire strength.

In the case of the belt 7 composed of the three plies of the belt cords laid at relatively small angles, due to such small angles, the radius of curvature of the belt 7 in the tire cross section tends to become smaller during running.

More specifically, the variations of the radius of curvature becomes large, especially the difference between the radius measured in the ground contacting patch and the radius measured out of the ground contacting patch becomes large when compared with the conventional four-ply rigid belt. Therefore, the belt cushion rubber layer 9 has a high degree of probability for causing a softening phenomenon due to mechanical fatigue during running, If such a softening phenomenon is caused, a separation failure becomes very liable to occur between the belt ply 7A and the carcass 6.

In order to prevent the softening phenomenon, the complex elastic modulus E*a of the belt cushion rubber layer 9 is increased more than conventional values, and for example set in a range of from 3.5 to 4.5 MPa. Thereby, the separation failure can be effectively controlled.

If the complex elastic modulus E*a is not more than 3.5 MPa, the decrease in the binding force between the belt ply 7A and the carcass 6 due to the softening phenomenon can not be prevented. If more than 4.5 MPa, the effect to mitigate the stress concentration on the axial edge e1 of the first belt ply 7A becomes insufficient. Thus, in either case, it becomes difficult to prevent the separation between the belt ply 7A and carcass 6.

For the similar reason, the complex elastic modulus E*b of the above-mentioned ply cushion rubber layer 21A is set in a range of from 5.5 to 8.0 MPa, and preferably, the modulus E*b is set to be more than the modulus E*a.

In this embodiment, in order to further improve the resistance to separation failure between the belt ply 7A and carcass 6, a protective rubber layer 23 having a thickness of from 1.0 to 3.0 mm and a complex elastic modulus E*c of from 7.0 to 11.0 MPa is disposed between the first belt ply 7A and carcass 6 and between the belt cushion rubber layers 9 and 9. In order to smoothen or make gradual characteristic changes due to the difference in the modulus between the protective rubber layer 23 and belt cushion rubber layer 9, the edge portions of the protective rubber layer 23 are overlapped with the thin axially inner edge portions of the belt cushion rubber layers 9 and 9, and the width L2 of each overlap 24 therebetween is preferably set in a range of from 10 to 20 mm in the tire axial direction.

Further, the axial width of the protective rubber layer 23 is preferably set to be more than the axial width W3 of the third belt ply 7C.

As a result, the protective rubber layer 23 can mitigate the share stress between the first belt ply 7A and carcass 6 to prevent separation failures, and further can prevent shock burst that might take place when running over a sharp object with a heavy tire load. The shock burst is such a phenomenon that the carcass cords are broken by a large impulsive force occurred when the tire runs over a relatively large sharp object, and from the broken position, a crack is caused and extends to the inside and outside of the tire through the tread portion, therefore, the air filled in the tire blows out in a short period of time.

The protective rubber layer 23 can reduce and disperse such impulsive force which is received by the carcass cords from the belt cords, therefore, the shock burst can be effectively prevented. If the thickness of the protective rubber layer 23 is less than 1.0 mm, as the share stress and impulsive force can not be effectively mitigated, it becomes difficult to control the separation failure and shock burst. If more than 3.0 mm, the belt cords and carcass cords forming the stiff truss structure are disengaged, and a result, the tread rigidity is decreased and the steering stability is deteriorated.

If the complex elastic modulus E*c of the protective rubber layer 23 is less than 7.0 MPa, the tread rigidity is decreased to deteriorate the steering stability. If more than 11.0 MPa, it is difficult to mitigate the share stress and impulsive force.

### Comparison Tests

Test tires, heavy duty radial tires of size 11R22.5 (rim size 7.5×22.5) for trucks and buses were prepared and tested for the tire strength, steering stability, and durability.

All of the test tires had the same structure shown in FIG. 1, except for the belt structures.

The following are specifications common to all of the test tires:

Cushion rubber 21
complex elastic modulus E*b: 4.0 MPa

Protective rubber layer 23
Complex elastic modulus E*c: 9.0 MPa
Thickness: 2.0 mm

Distance L1 between 2nd ply's end e2 and 1st ply: 2.0 mm other specifications are shown in Table 1.

### (1) Mass of Tire

The mass of each of the test tires is indicated by an index based on conventional tire having four-ply structure being

### (2) Tire Strength Test (Tire Breaking Energy)

The test was carried out as follows. The surface layer of the tread portion or tread rubber of the test tire was removed so that circumferentially-extending main tread grooves become 5 mm in depth in order to simulate a worn tread portion. Then, the tire was mounted on a wheel rim, and the inside of the tire was filled with water, instead of air, up to a pressure of 12 kPa. The tire-rim assembly was held vertically, and a plunger having a mass of 230 kg and a semispherical tip end of 600 mm radius was freely fallen down onto the tread surface repeatedly, gradually increasing the height of the falling, until the tire was broken.

Based on the falling height when the tire was broken, the breaking energy (J) was calculated as the product of the height in meter and the mass (230 kg) of the plunger and the acceleration of free fall (9.8 m/ŝ2). The results are shown in Table 1. The larger the value, the better the resistance to shock burst. It is especially preferable that the breaking energy is more than 1000 J.

### (3) Steering Stability Test

Using a tire test drum, a cornering force of the test tire was measured under the following conditions:

Tire load: vertical load of 26.7 kN

slip angle: 5 degrees

Tire pressure: 800 kPa

Diameter of drum: 1.7 m

The results are indicated in Table 1 by an index based on conventional tire being 100, wherein the larger the value, the better the steering stability.

### (4) Durability Test

Using the tire test drum, the test tire was run for 100,000 km under a vertical tire load of 26.7 kN and tire pressure of 800 kPa.

Then, the tire was disassembled and checked for
(A) separation between the first belt ply and carcass, and
(B) separation between the first belt ply and second belt ply and the conditions were evaluated.
The results are indicated in Table 1 by an index based on Conventional tire being 100, wherein the larger the value, the better the condition.

From the test results, it was confirmed that, according to the present invention, the breaking energy can be increased, while reducing the mass of the tire, and the separation failures can be effectively controlled to improve the durability.

TABLE 1

| Tire | Ex. 1 | Ex. 2 | Ex. 3 | Ex. 4 | Ex. 5 | Ex. 6 | Ex. 7 |
|---|---|---|---|---|---|---|---|
| 1st belt ply | | | | | | | |
| ply strength S1 (kN/5 cm) | 65.1 | 70.9 | 55.9 | 65.1 | 65.1 | 65.1 | 65.1 |
| load at break E1 (kN) | 3.1 | 3.1 | 3.1 | 3.1 | 3.1 | 3.1 | 3.1 |
| cord count N1/5 cm | 21 | 23 | 18 | 21 | 21 | 21 | 21 |
| angle θ1 (deg.) | 19 | 19 | 19 | 19 | 19 | 19 | 19 |
| 2nd belt ply | | | | | | | |
| ply strength S2 (kN/5 cm) | 43 | 43 | 43 | 43 | 43 | 43 | 43 |
| load at break E2 (kN) | 1.65 | 1.65 | 1.65 | 1.65 | 1.65 | 1.65 | 1.65 |
| cord count N2/5 cm | 26 | 26 | 26 | 26 | 26 | 26 | 26 |
| angle θ2 (deg.) | 19 | 19 | 19 | 19 | 19 | 19 | 19 |
| 3rd belt ply | | | | | | | |
| ply strength S3 (kN/5 cm) | 43 | 43 | 43 | 43 | 43 | 43 | 43 |
| load at break E3 (kN) | 1.65 | 1.65 | 1.65 | 1.65 | 1.65 | 1.65 | 1.65 |
| cord count N3/5 cm | 26 | 26 | 26 | 26 | 26 | 26 | 26 |
| angle θ3 (deg.) | 19 | 19 | 19 | 19 | 19 | 19 | 19 |
| 4th belt ply | | | | | | | |
| ply strength S4 (kN/5 cm) | — | — | — | — | — | — | — |
| cord load at break E4 (kN) | — | — | — | — | — | — | — |
| cord count N4/5 cm | — | — | — | — | — | — | — |
| cord angle θ4 (deg.) | — | — | — | — | — | — | — |
| Ratio S1/S2 | 1.51 | 1.65 | 1.30 | 1.51 | 1.51 | 1.51 | 1.51 |
| Belt cushion rubber layer | 4.0 | 4.0 | 4.0 | 4.4 | 4.5 | 3.6 | 3.5 |
| complex elastic modulus E* (MPa) | | | | | | | |
| Tire mass | 97.0 | 98.0 | 96.0 | 97.0 | 97.0 | 97.0 | 97.0 |
| Breaking energy | 1090 | 1210 | 1030 | 1090 | 1090 | 1090 | 1090 |
| Steering stability | 105 | 109 | 103 | 105 | 106 | 105 | 105 |
| Durability | | | | | | | |
| (A) between 1st ply and carcass | 130 | 120 | 120 | 120 | 120 | 120 | 120 |
| (B) between 1st and 2nd plies | 110 | 110 | 110 | 100 | 100 | 100 | 100 |

| Tire | Conv. | Ref. 1 | Ref. 2 | Ref. 3 | Ref. 4 | Ref. 5 |
|---|---|---|---|---|---|---|
| 1st belt ply | | | | | | |
| ply strength S1 (kN/5 cm) | 33 | 55.9 | 65.1 | 65.1 | 74.4 | 52.7 |
| load at break E1 (kN) | 1.65 | 2.66 | 3.1 | 3.1 | 3.1 | 3.1 |
| cord count N1/5 cm | 20 | 21 | 21 | 21 | 24 | 17 |
| angle θ1 (deg.) | 50 | 19 | 19 | 19 | 19 | 19 |
| 2nd belt ply | | | | | | |
| ply strength S2 (kN/5 cm) | 43 | 55.9 | 43 | 43 | 43 | 43 |
| load at break E2 (kN) | 1.65 | 2.66 | 1.65 | 1.65 | 1.65 | 1.65 |
| cord count N2/5 cm | 26 | 21 | 26 | 26 | 26 | 26 |
| angle θ2 (deg.) | 19 | 19 | 19 | 19 | 19 | 19 |
| 3rd belt ply | | | | | | |
| ply strength S3 (kN/5 cm) | 43 | 43 | 43 | 43 | 43 | 43 |
| load at break E3 (kN) | 1.65 | 1.65 | 1.65 | 1.65 | 1.65 | 1.65 |
| cord count N3/5 cm | 26 | 26 | 26 | 26 | 26 | 26 |
| angle θ3 (deg.) | 19 | 19 | 19 | 19 | 19 | 19 |
| 4th belt ply | | | | | | |
| ply strength S4 (kN/5 cm) | 43 | — | — | — | — | — |
| cord load at break E4 (kN) | 1.65 | — | — | — | — | — |
| cord count N4/5 cm | 26 | — | — | — | — | — |
| cord angle θ4 (deg.) | 19 | — | — | — | — | — |
| Ratio S1/S2 | 1.00 | 1.00 | 1.51 | 1.51 | 1.70 | 1.23 |
| Belt cushion rubber layer | 3.3 | 4.0 | 4.7 | 3.2 | 4.0 | 4.0 |
| complex elastic modulus E* (MPa) | | | | | | |
| Tire mass | 100 | 96.0 | 97.0 | 97.0 | 98.0 | 96.0 |
| Breaking energy | 770 | 1030 | 1090 | 1090 | 1250 | 1010 |
| Steering stability | 100 | 102 | 105 | 106 | 108 | 100 |
| Durability | | | | | | |
| (A) between 1st ply and carcass | 100 | 110 | 100 | 100 | 110 | 100 |
| (B) between 1st and 2nd plies | 100 | 100 | 95 | 95 | 100 | 100 |

1. A heavy duty tire comprising
a tread portion,
a pair of sidewall portions,
a pair of bead portions each with a bead core therein,
a carcass extending between the bead portions through the tread portion and sidewall portions,
a belt disposed radially outside the carcass in the tread portion, and
a belt cushion rubber layer having a wedge-shaped cross sectional shape and inserted between the carcass and each axial edge portion of the belt, wherein
the belt is made up of three plies: a radially innermost first ply, a middle second belt ply thereon and a radially outermost third belt ply thereon, each made of parallel steel cords inclined at an angle in a range of from 15 to 23 degrees with respect to the tire equator,
with respect to the tire equator, the inclination of the belt cords of the first belt ply is opposite to the inclination of the belt cords of the second belt ply,
the axial width W2 of the second belt ply is less than the axial width W1 of the first belt ply and more than the axial width W3 of the third belt ply,
the ply strength S1 of the first belt ply, the ply strength S2 of the second belt ply, and the ply strength S3 of the third belt ply satisfy the following conditions (1)-(4):
(1) S1>S2
(2) S1>S3
(3) 55≦S1≦75 and
(4) 1.25≦S1/S2≦1.65, and
the complex elastic modulus of the belt cushion rubber layer is in a range of from 3.5 to 4.5 MPa.

2. The heavy duty tire according to claim 1, wherein
the ply strength S2 of the second belt ply is not less than the ply strength S3 of the belt ply,
with respect to the tire equator, the inclining direction of the belt cords of the second belt ply is the same as the inclining direction of the belt cords of the third belt ply, and
the axially outer end of the second belt ply is at a distance L1 of not less than 2.0 mm from the first belt ply.

3. The heavy duty tire according to claim 1 or 2, which further comprises a protective rubber layer having a thickness of from 1.0 to 3.0 mm and a complex elastic modulus of from 7.0 to 11.0 MPa, and inserted between the first belt ply and the carcass to be centered on the tire equator.
